(19) United States
(12) Patent Application Publication
(10) Pub. No.: US 2013/0064117 A1
(43) Pub. Date: Mar. 14, 2013

(54) RELAY NODE SIMULATOR AND TEST METHOD

(71) Applicants: Reiichi Hashimoto, Atsugi-shi (JP); Syun Hosokawa, Atsugi-shi (JP)

(72) Inventors: Reiichi Hashimoto, Atsugi-shi (JP); Syun Hosokawa, Atsugi-shi (JP)

(73) Assignee: ANRITSU CORPORATION, Atsugi-shi (JP)

(21) Appl. No.: 13/595,242

(22) Filed: Aug. 27, 2012

(30) Foreign Application Priority Data
Sep. 9, 2011 (JP) 2011-197048

(51) Int. Cl. H04W 24/00

(52) U.S. Cl. 370/252

(57) ABSTRACT

A relay node simulator that outputs a test signal obtained by simulating a signal in which a first RF signal from a base station and a second RF signal transmitted to a mobile communication terminal by a relay node receiving the first RF signal are multiplexed, the relay node simulator including a relay processing unit that generates a second baseband signal on the basis of a first baseband signal, a delay processing unit that provides a predetermined delay to the second baseband signal, a gain adjustment unit that changes a level of the first baseband signal, an adder that adds the first baseband signal and the second baseband signal, and a transmission unit that converts an added signal into an RF signal and transmits a converted signal as the test signal.

### TECHNICAL FIELD

The present invention relates to a technique of a relay node simulator for simulating a relay node that relays communication between a base station and a mobile communication terminal.

### BACKGROUND ART

As a wireless access scheme of next-generation mobile communication systems, the standardization of LTE-Advanced which further develops LTE (Long Term Evolution) is progressing using 3GPP. In LTE-Advanced, a relay technique for regenerating and relaying wireless signals between a base station and a mobile communication terminal at a layer 3 level is being examined. It is expected to expand effective coverage in a place and the like in which it is difficult to secure a wired backhaul channel for connecting devices constituting a mobile communication system such as a switching station and a wireless base station in a wired manner, by applying a relay node in which such a relay technique is used (Patent Document 1).

In such a relay node, the wireless backhaul channel between the base station and the relay node and the wireless access channel between the relay node and the mobile communication terminal may be operated at the same frequency. In such a case, when sufficient isolation is not secured between these channels, a transmission signal is turned around a receiving unit of the relay node, and thus causes interference. For this reason, in the case of an operation at the same frequency, time division multiplexing (TDM) is performed on wireless resources of the wireless backhaul channel and the wireless access channel, and the wireless resources are controlled so that transmission and reception are not performed simultaneously in the relay node. Thereby, the mobile communication terminal receives a signal transmitted from the base station and a signal transmitted from the relay node in a time-division manner. Thereby, even when an area in which the base station delivers a signal and an area in which the relay node delivers a signal overlap each other, these signals are received in the mobile communication terminal without interference with each other. Meanwhile, in addition to the aforementioned configuration, a configuration is also being examined in which a signal continues to be output from the base station, and allocation of resource elements is controlled with respect to the signal from the base station and the signal from the relay node, to thereby prevent interference between these signals, but the present invention can be applied to such a configuration as well. Hereinafter, the aforementioned configuration of time division multiplexing will be described by way of example.

However, there may be a case where depending on a positional relationship between the base station, the relay node, and the mobile communication terminal, the level of each signal fluctuates, or a delay occurs in any of the signals. For example, until the level of a signal transmitted from the base station is received by the mobile communication terminal, the level is attenuated depending on the distance between the base station and the mobile communication terminal. Similarly, until the level of a signal transmitted from the relay node is received by the mobile communication terminal, the level is attenuated depending on the distance between the relay node and the mobile communication terminal. In addition, when a delay occurs in any of the signals, interference may occur between these signals. For this reason, on the assumption that such a fluctuation or a delay of the level of the signal occurs, it is necessary to verify an operation of the mobile communication terminal which is a terminal under test, and a simulator that simulates such an environment is required.

### RELATED ART DOCUMENT

### Patent Document

[Patent Document 1] Japanese Unexamined Patent Application Publication No. 2011-82678

### DISCLOSURE OF THE INVENTION

### Problem That the Invention Is To Solve

An object of the present invention is to provide a relay node simulator capable of simulating a signal from a base station and a signal from a relay node in accordance with a positional relationship between the base station, the relay node, and a terminal under test.

### Means For Solving the Problem

In order to achieve the above-mentioned object, the present invention according to claim 1 provides a relay node simulator (1) that outputs a test signal obtained by simulating a signal in which a first RF signal from a base station and a second RF signal transmitted to a mobile communication terminal by a relay node receiving the first RF signal are multiplexed, including: a relay processing unit (12) that receives a first baseband signal corresponding to the first RF signal and generates a second baseband signal corresponding to the second RF signal on the basis of the first baseband signal; a delay processing unit (132) that provides a predetermined delay to the second baseband signal; a gain adjustment unit (143) that receives the first baseband signal and changes a level of the first baseband signal; an adder (15) that adds the first baseband signal, the level of which is changed and the second baseband signal provided with the delay; and a transmission unit (16) that converts an added signal into an RF signal and transmits a converted signal as the test signal.

In addition, the present invention according to claim 2 provides the relay node simulator according to claim 1, further including: a level detection unit (141) that detects a level (Penb) of the first baseband signal; an operation unit (18) for inputting a desired value (Guser) of a level difference between a level of the first RF signal and a level of the second RF signal; and a gain determination unit (142) that determines a gain on the basis of the detected level of the first baseband signal and the desired value of the level difference, wherein the gain adjustment unit changes the level of the first baseband signal on the basis of the determined gain.

In addition, the present invention according to claim 3 provides the relay node simulator according to claim 2, wherein the first baseband signal is formed by a frame in which a plurality of resource elements are arranged, and a resource element located at a predetermined position in the plurality of resource elements is a pilot signal, a level of which does not fluctuate during a predetermined period of time, the relay processing unit extracts the pilot signal included in the first baseband signal, and the level detection unit detects a level of the extracted pilot signal as the level of the first baseband signal.

In addition, the present invention according to claim 4 provides a test method of transmitting, to a mobile communication terminal to be tested, a test signal obtained by simulating a signal in which a first RF signal from a base station and a second RF signal transmitted to a mobile communication terminal by a relay node receiving the first RF signal are multiplexed, including: a relay processing step of receiving a first baseband signal corresponding to the first RF signal and generating a second baseband signal corresponding to the second RF signal on the basis of the first baseband signal; a delay processing step of providing a predetermined delay to the second baseband signal; a gain adjustment step of receiving the first baseband signal and changing a level of the first baseband signal; an addition step of adding the first baseband signal, the level of which is changed and the second baseband signal provided with the delay; and a transmission step of converting an added signal into an RF signal and transmitting a converted signal as the test signal.

In addition, the present invention according to claim 5 provides the test method according to claim 4, further including: a level difference acquisition step of acquiring a desired value (Guser) of a level difference between a level of the first RF signal and a level of the second RF signal; a level detection step of detecting a level (Penb) of the first baseband signal; and a gain determination step of determining a gain on the basis of the detected level of the first baseband signal and the desired value of the level difference, wherein in the gain adjustment step, the level of the first baseband signal is changed on the basis of the determined gain.

In addition, the present invention according to claim 6 provides the test method according to claim 5, wherein the first baseband signal is formed by a frame in which a plurality of resource elements are arranged, and a resource element located at a predetermined position in the plurality of resource elements is a pilot signal, a level of which does not fluctuate during a predetermined period of time, in the relay processing step, the pilot signal included in the first baseband signal is extracted, and in the level detection step, a level of the extracted pilot signal is detected as the level of the first baseband signal.

### Advantage of the Invention

According to the technique of the present invention, there is provided a relay node simulator that relays a first RF signal from a base station to simulate a relay node transmitting the signal as a second RF signal to a mobile communication terminal, and simulates the relay node transmitting, to a mobile communication terminal to be tested, a test signal obtained by simulating a signal in which the first RF signal and the second RF signal are multiplexed, the relay node simulator including a delay processing unit and a gain adjustment unit. With such configurations, a delay is performed on a second baseband signal, and a gain of a first baseband signal is adjusted, thereby allowing the relay node simulator to simulate an RF signal from the base station and an RF signal from the relay node in accordance with a positional relationship between the base station, the relay node, and the terminal under test.

### BRIEF DESCRIPTION OF THE DRAWINGS

FIG. 1 is a block diagram illustrating a schematic configuration of a relay node simulator according to the present invention.

FIG. 2 is a block diagram illustrating a detailed configuration of a downlink processing unit.

FIG. 3 is a schematic diagram illustrating a positional relationship between a base station, a relay node, and a mobile communication terminal.

FIG. 4A is a schematic diagram illustrating a relationship between a signal from the base station and a signal from the relay node.

FIG. 4B is a schematic diagram illustrating a relationship between a signal from the base station and a signal from the relay node.

FIG. 4C is a schematic diagram illustrating a relationship between a signal from the base station and a signal from the relay node.

FIG. 5 is a flow diagram illustrating a series of operations of the downlink processing unit.

### BEST MODE FOR CARRYING OUT THE INVENTION

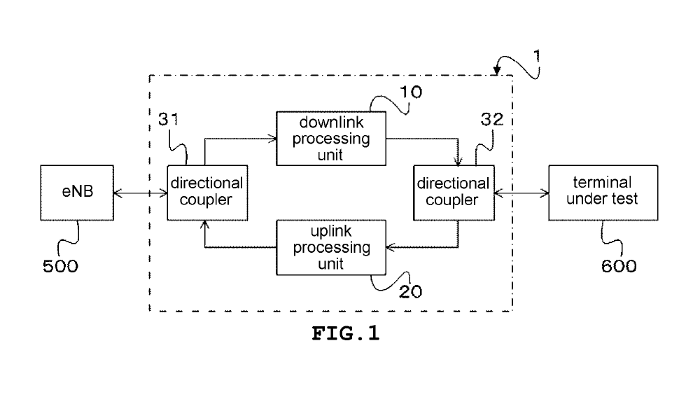

A relay node simulator 1 according to the present invention is a simulator for simulating a relay node. As shown in FIG. 1, the relay node simulator 1 lies between an eNB (base station simulator) 500 and a terminal under test 600. The relay node simulator 1 includes a downlink processing unit 10, an uplink processing unit 20, a directional coupler 31, and a directional coupler 32.

The directional coupler 31 receives an RF signal (that is, base station signal) E0′ from the eNB 500, and transmits the signal to the downlink processing unit 10. In addition, the directional coupler 31 receives a signal from the uplink processing unit 20, and transmits the signal to the eNB 500.

The downlink processing unit 10 is a processing block for simulating a process relating to a downlink of a relay node. The downlink processing unit 10 receives the analog RF signal E0′ transmitted from the eNB 500 through the directional coupler 31. The downlink processing unit 10 generates a baseband signal E1 as an output of the relay node on the basis of the signal from the eNB 500, synthesizes a baseband signal E0 from the eNB 500 with the baseband signal E1 to convert the synthesized signal into a RF signal, and transmits the signal as a test signal toward the terminal under test 600. A detailed configuration and an operation of the downlink processing unit 10 will be described later.

The directional coupler 32 receives the test signal from the downlink processing unit 10, and transmits the signal to the terminal under test 600. In addition, the directional coupler 32 receives a signal transmitted from the terminal under test 600, and transmits the signal to the uplink processing unit 20.

The uplink processing unit 20 is a processing block for simulating a process relating to an uplink of the relay node. The uplink processing unit 20 receives an analog RF signal transmitted from the terminal under test 600 through the directional coupler 32. The uplink processing unit 20 demodulates the RF signal, and decodes the demodulated signal into digital data on the basis of a predetermined communication scheme. The uplink processing unit 20 rewrites data equivalent to a control signal in the decoded digital data, on the basis of setting of the relay node. The uplink processing unit 20 encodes the digital data on the basis of a predetermined communication scheme, and modulates the encoded digital data into an analog RF signal to transmit it to toward the eNB 500. Meanwhile, a specific operation of the uplink processing unit 20 is defined by “3GPP TS36.211 V10.0.0” and the like.

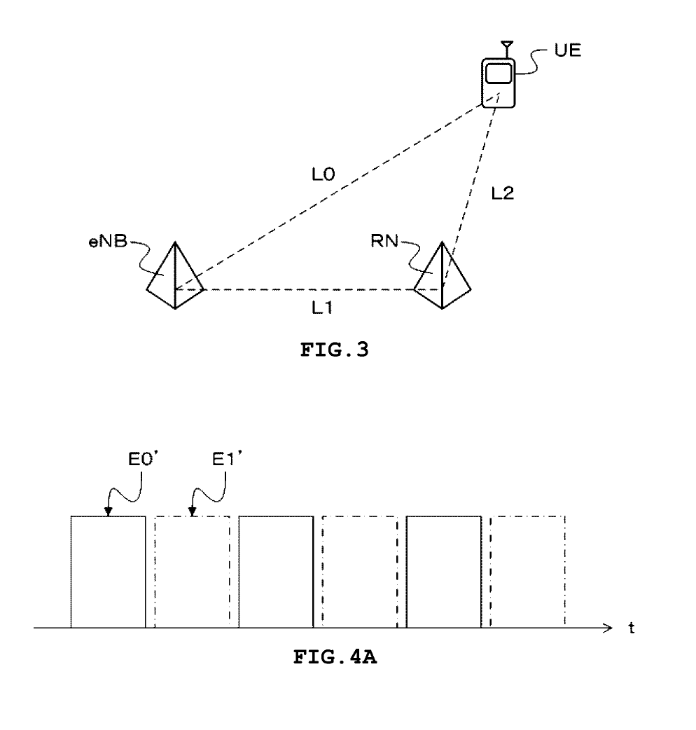

Next, the details of the downlink processing unit 10 will be described. First, a description will be made with reference to FIG. 3. FIG. 3 is a diagram schematically illustrating a positional relationship between a base station eNB, a relay node RN, and a mobile communication terminal UE. For example, the distance between the base station eNB and the mobile communication terminal UE is set to L0, the distance between the base station eNB and the relay node RN is set to L1, and the distance between the relay node RN and the mobile communication terminal UE is set to L2.

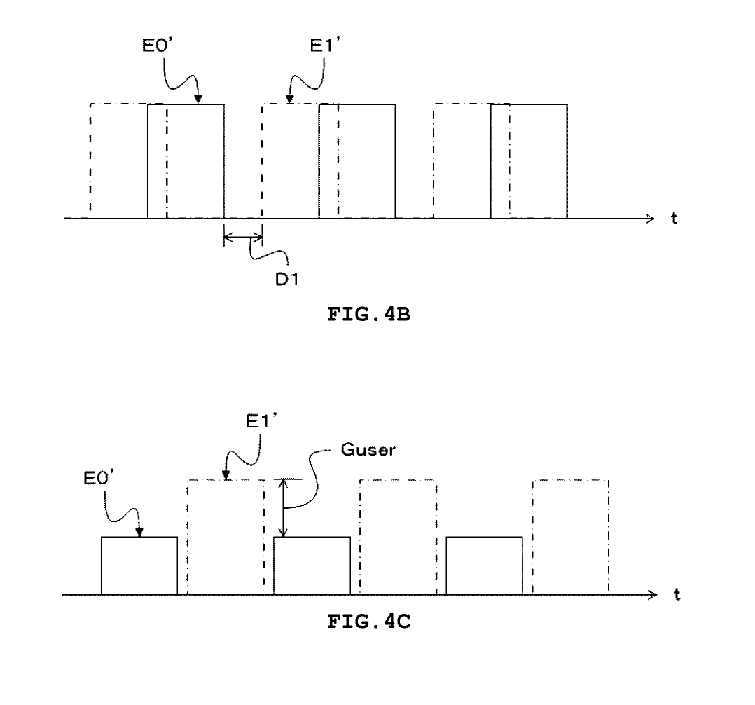

When the relay node RN is a layer-3 relay node, the RF signal E0′ transmitted from the base station eNB and an RF signal E1′ output from the relay node RN by relaying the RF signal E0′ are treated as signals different from each other. In such a case, when the RF signal E0′ and the RF signal E1′ are transmitted at the same frequency, there is a possibility that the transmission signal (RF signal E1′) from the relay node RN is turned around the receiving side (RF signal E0′) of the relay node RN and thus causes interference. For this reason, in such a case, the relay node RN performs reception of the RF signal E0′ transmitted from the base station eNB and transmission of the RF signal E1′ toward the mobile communication terminal UE in a time-division manner. In such a case, the RF signal E0′ transmitted from the base station eNB is time-divided for each sub-frame and is transmitted to the mobile communication terminal or the relay node at a predetermined timing. The relay node RN receives the RF signal E0′ in accordance with this timing, and transmits the RF signal E1′ toward the mobile communication terminal UE at a timing different from that of the reception of the RF signal E0′. In an area capable of receiving both the RF signal E0′ and the RF signal E1′, the RF signal E0′ and the RF signal E1′ are transmitted toward the mobile communication terminal UE in a time-division manner. FIG. 4A shows an outline of a relationship between the RF signal E0′ and the RF signal E1′ in such a case.

The mobile communication terminal UE ideally receives the RF signal E1′ and the RF signal E0′ in a time-division manner as shown in FIG. 4A. However, there may be a case where attenuation or delay of these signals occurs depending on the positional relationship between the base station eNB, the relay node RN, and the mobile communication terminal UE. In the following, in order to facilitate understanding, a description will be made on the assumption that the signal output level of the base station eNB and the signal output level of the relay node RN are the same as each other. For example, FIG. 4B shows a case where the delay occurs in the RF signal E1′. In such a case, the interference occurs between the RF signal E0′ and the RF signal E1′. In addition, the RF signal E0′ is attenuated depending on the distance L0. For example, FIG. 4 C shows a case of the distance L0>L2, and in this case, the level of the RF signal E0′ decreases with respect to the level of the RF signal E1′. The downlink processing unit 10 of the relay node simulator according to the present embodiment simulates such an environment, and tests an operation of the terminal under test 600 equivalent to the mobile communication terminal UE. Meanwhile, in this case, the eNB 500 is equivalent to the base station eNB, and the downlink processing unit 10 simulates the downlink processing portion of the relay node RN, and the level difference and the delay between the signal from the base station eNB and the signal of the relay node RN depending on the difference in distance between the distances L0 and L2. Specifically, the downlink processing unit 10 receives the RF signal E0′ from the eNB 500, generates the RF signal E1′ on the basis thereof, and adds the RF signal E0′ and the RF signal E1′ to transmit the added signal toward the terminal under test 600 (that is, mobile communication terminal).

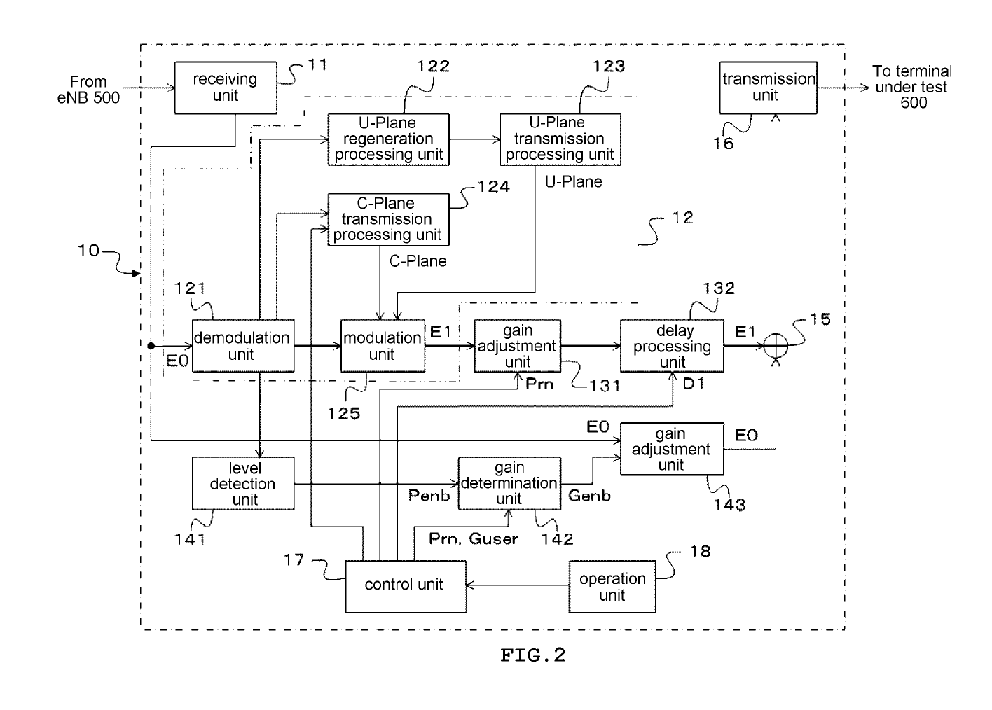

The configuration of the downlink processing unit 10 will be described with reference to FIG. 2. FIG. 2 is a block diagram illustrating a detailed configuration of the downlink processing unit 10. As shown in FIG. 2, the downlink processing unit 10 includes a receiving unit 11, a relay processing unit 12, a gain adjustment unit 131, a delay processing unit 132, a level detection unit 141, a gain determination unit 142, a gain adjustment unit 143, an adder 15, a transmission unit 16, and a control unit 17. The relay processing unit 12 is configured to simulate a baseband signal process of the actual relay node, and to generate a baseband signal to be generated by the actual relay node. The baseband signal to be generated by the relay node is a baseband signal corresponding to an RF signal transmitted toward the mobile communication terminal by the relay node. The relay processing unit 12 includes a demodulation unit 121, a U-Plane regeneration processing unit 122, a U-Plane transmission processing unit 123, a C-Plane transmission processing unit 124, and a modulation unit 125.

The receiving unit 11 receives the RF signal E0′ transmitted from the eNB 500 in a time-division manner on the basis of a predetermined timing. The receiving unit 11 frequency-converts the received RF signal into an IF (intermediate frequency) signal, and performs an A/D conversion and a frequency shift on this IF signal, to thereby obtain a digital baseband signal E0. The baseband signal E0 is a baseband signal corresponding to the RF signal E0′. The receiving unit 11 outputs the baseband signal E0 to the demodulation unit 121 and the gain adjustment unit 143.

The demodulation unit 121, the U-Plane regeneration processing unit 122, the U-Plane transmission processing unit 123, the C-Plane transmission processing unit 124, and the modulation unit 125 are equivalent to configurations of portions which perform a demodulation and decoding process and an encoding and modulation process of the simulated relay node RN. For this reason, these configurations operate in conformity to a protocol (for example, 3GPP TS36.211 V10.0.0) of a predefined communication scheme. Hereinafter, an example of the configurations will be described.

The demodulation unit 121 receives the baseband signal E0 from the receiving unit 11, and performs a demodulation process. The demodulated signal has a frame structure based on an encoding system (for example, OFDMA) in accordance with a predetermined communication scheme (LTE).

The demodulation unit 121 extracts a reference signal called Cell-Specific RS (Cell-Specific Reference Signal) from the demodulated signal. The Cell-Specific RS is allocated to a resource element of a predetermined position in one sub-frame, and serves as a pilot signal. Meanwhile, the details of the Cell-Specific RS are described in “3GPP TS36.211 V10.0.0”. When the reference signal (Cell-Specific RS) is extracted from the resource element of the predetermined position in one sub-frame, the demodulation unit 121 outputs this reference signal to the level detection unit 141. The level of the Cell-Specific RS is set in advance, and does not fluctuate in at least one sub-frame. For this reason, the level detection unit 141 specifies the level of the signal from the base station on the basis of the signal of the Cell-Specific RS. The details of the level detection unit 141 will be described later.

In addition, the demodulation unit 121 decodes a signal demodulated on the basis of the predetermined communication scheme mentioned above and extracts digital data. The demodulation unit 121 outputs the extracted digital data to the U-Plane regeneration processing unit 122. In addition, the demodulation unit 121 sends out information for generating a C-Plane to the C-Plane transmission processing unit 124. In addition, the demodulation unit 121 notifies the modulation unit 125 of a synchronization timing of the baseband signal E0.

Herein, a protocol configuration of digital data extracted by decoding the demodulated signal will be described. The data includes a U-Plane (User Plane) protocol and a C-Plane (Control Plane) protocol. The U-Plane protocol is a protocol that treats user data. Hereinafter, this protocol is simply called a U-Plane. In addition, the C-Plane protocol is a protocol that treats data for performing a control. Hereinafter, this protocol is simply called a C-Plane.

The U-Plane regeneration processing unit 122 receives digital data from the demodulation unit 121. The U-Plane regeneration processing unit 122 regenerates the U-Plane from digital data on the basis of control information included in the C-Plane of the digital data. The U-Plane regeneration processing unit 122 outputs the regenerated U-Plane to the U-Plane transmission processing unit 123.

The U-Plane transmission processing unit 123 receives the U-Plane from the U-Plane regeneration processing unit 122. The U-Plane transmission processing unit 123 has the same wireless control function as that of the base station. This wireless control function includes, for example, a PDCP (Packet Data Convergence Protocol) sublayer, an RLC (Radio Link Control) sublayer, a MAC (Medium Access Control) sublayer, and an RRC (Radio Resource Control) sublayer. The PDCP sublayer performs confidency and header compression of the user data, and the like. In addition, the RLC sublayer performs a retransmission control and a SDU (Service Data Unit) division, and a coupling and sequence control by an ARQ (Automatic Repeat reQuest), and the like. In addition, the MAC sublayer performs HARQ and user data scheduling and the like. In addition, the RRC sublayer performs mobility, QoS, a security control, and the like. The U-Plane transmission processing unit 123 performs a wireless control thereof on the received U-Plane. The U-Plane transmission processing unit 123 outputs the U-Plane, on which the wireless control is performed, to the modulation unit 125.

The C-Plane transmission processing unit 124 receives information from the demodulation unit 121 and the control unit 17, and generates data for controlling a network between the relay node RN simulated by the downlink processing unit 10 and the terminal under test 600, that is, the C-Plane. For example, setting of a transmission path between the simulated relay node RN and the terminal under test 600, a control of handover, or the like is performed on the basis of the generated C-Plane. The C-Plane transmission processing unit 124 outputs the generated C-Plane to the modulation unit 125.

The modulation unit 125 receives the U-Plane from the U-Plane transmission processing unit 123. In addition, the modulation unit 125 receives the C-Plane from the C-Plane transmission processing unit 124. The modulation unit 125 generates digital data by the received C-Plane and the U-Plane. The modulation unit 125 performs encoding and digital modulation on the generated digital data on the basis of a predetermined communication scheme and generates a baseband signal. In addition, the modulation unit 125 receives a synchronization timing from the demodulation unit 121. The modulation unit 125 performs a delay process on this baseband signal so that the generated baseband signal is in synchronization with the received synchronization timing. The modulation unit 125 outputs the baseband signal E1, on which the delay process is performed, to the gain adjustment unit 131.

The gain adjustment unit 131 receives the baseband signal E1 from the modulation unit 125. In addition, the gain adjustment unit 131 receives, from the control unit 17, information indicating level Prn of a signal which is output from the relay node set in advance as a measurement condition. The gain adjustment unit 131 determines a gain so that the level of the baseband signal E1 is changed to the level Prn, and adjusts the level of the baseband signal E1 on the basis of the gain.

Meanwhile, the gain adjustment unit 131 may calculate the amount of attenuation of the baseband signal E1 between the relay node RN assumed to be a real line and the terminal under test 600 (that is, mobile communication terminal UE), and may adjust a gain so that the level of the baseband signal E1 is changed to a level attenuated by this amount of attenuation from the level Prn. In this case, the gain adjustment unit 131 may receive, from the control unit 17, information indicating a distance (for example, distance L2) between the relay node set in advance and the terminal under test 600, and may calculate the amount of attenuation of the baseband signal on the basis of information indicating the distance.

The gain adjustment unit 131 outputs the baseband signal E1 of which the level is adjusted to the delay processing unit 132.

The delay processing unit 132 receives the baseband signal E1 of which the level is adjusted to the gain adjustment unit 131. In addition, the delay processing unit 132 receives information indicating a delay D1 from the control unit 17. The delay processing unit 132 provides the delay D1 to the baseband signal E1. Meanwhile, as described later, the baseband signals E0 and E1 are added and frequency-converted, and become an RF signal which is a test signal. This test signal includes the RF signal E0′ into which the baseband signal E0 is frequency-converted, and the RF signal E1′ into which the baseband signal E1 is frequency-converted. Herein, FIG. 4B shows a relationship between the RF signal E1′ provided with the delay by the delay processing unit 132 and the RF signal E0′ transmitted from the eNB 500. In this manner, the delay of the RF signal E1′ based on the positional relationship between the base station eNB, the relay node RN, and the mobile communication terminal UE is simulated by performing the delay D1 on the RF signal E1′ by the delay processing unit 132. Thereby, it is possible to simulate interference between the RF signal E0′ and the RF signal E1′ due to this delay. The delay processing unit 132 outputs the baseband signal E1 provided with the delay to the adder 15.

Next, a configuration of the downlink processing unit 10 relating to an output of the baseband signal E0 will be described. The downlink processing unit 10 adjusts and outputs the level of the baseband signal E0, and thus simulates attenuation of the RF signal E0′ due to the distance L0 between the eNB 500 (that is, base station eNB) and the terminal under test 600 (that is, mobile communication terminal UE) as shown in FIG. 4C. The configurations which simulate such attenuation is the level detection unit 141, the gain determination unit 142, and the gain adjustment unit 143. Each of the configurations will be described below. Meanwhile, the relay node simulator according to the present invention is configured such that the baseband signal of which the level is controlled is frequency-converted and is set to an RF signal, to thereby output the RF signal of which the level is controlled.

The level detection unit 141 receives a reference signal from the demodulation unit 121. The level detection unit 141 detects the level of the reference signal as the level of the baseband signal E0. At this time, the level detection unit 141 detects, for example, an average value of reference signals in one sub-frame as a level Penb of the baseband signal E0. In addition, level detection unit 141 may further acquire the average value of reference signals in one sub-frame during several ms, and may set a value smoothed by taking a moving average thereof as the level of the baseband signal E0. In addition, levels are not necessarily detected with respect to all the reference signals in one sub-frame, and for example, some of these reference signals may be decimated. The level detection unit 141 outputs the detected level Penb to the gain determination unit 142.

The gain determination unit 142 receives the level Penb of the baseband signal E0, received from the eNB 500, from the level detection unit 141. In addition, the gain determination unit 142 receives, from the control unit 17, information indicating the level Prn set in advance as the measurement condition and information indicating the level difference Guser. The level Prn shows the level of the RF signal E1′ which is output from the simulated relay node RN. In addition, the level difference Guser shows the level difference between the RF signal E0′ and the RF signal E1′ as shown in FIG. 4C. In this case, when the level of the RF signal E0′ after the attenuation as shown in FIG. 4C is set to Penb′, the expression of Penb′=Prn−Guser is established. The gain determination unit 142 calculates gain Genb for adjusting the level of the RF signal E0′ (that is, the level of the baseband signal E0) from Penb to Penb′, on the basis of the expression of Genb=Penb′−Penb=Prn−Penb−Guser. The gain determination unit 142 outputs information indicating the calculated gain Genb to the gain adjustment unit 143.

The gain adjustment unit 143 receives the baseband signal E0 from the receiving unit 11. In addition, the gain adjustment unit 143 receives information indicating the gain Genb from the gain determination unit 142. The gain adjustment unit 143 performs an adjustment by attenuating or amplifying the level of the baseband signal E0 on the basis of the gain Genb. Thereby, the level of the baseband signal E0 is adjusted to the level Penb′ as shown in FIG. 4C. Thereby, it is possible to simulate the attenuation of the RF signal E0′ depending on the distance L0 between the base station eNB and the mobile communication terminal UE. In addition, in this manner, an operator designates the desired level difference Guser as in a case where the SN ratio is set, by bringing the gain determination unit 142 and the gain adjustment unit 143 into operation, thereby allowing the gain Genb for adjusting the level of the baseband signal E0 to be set. The gain adjustment unit 143 outputs the baseband signal E0 of which the level is adjusted to the adder 15.

The adder 15 receives the baseband signal E1 provided with the delay from the delay processing unit 132. In addition, the adder 15 receives the baseband signal E0 of which the level is adjusted from the gain adjustment unit 143. The adder 15 adds the baseband signal E0 and the baseband signal E1, and outputs the added signal to the transmission unit 16. The transmission unit 16 performs D/A conversion and frequency conversion on the added signal, and transmits an RF signal obtained thereby as a test signal toward the terminal under test 600.

The control unit 17 is configured to receive an input of the measurement condition or setting information of the relay node RN from an operator through an operation unit 18 constituted by a keyboard, a mouse and the like. The control unit 17 receives the level Prn, the level difference Guser, and the delay D1 which are indicated as the measurement condition. The control unit 17 outputs the level Prn to the gain adjustment unit 131. The gain adjustment unit 131 adjusts the level of the baseband signal E1 by receiving this level. In addition, the control unit 17 outputs the delay D1 to the delay processing unit 132. The delay processing unit 132 provides the delay D1 to the baseband signal E1 by receiving this delay. In addition, the control unit 17 outputs the level Prn and the level difference Guser to the gain determination unit 142. The gain determination unit 142 calculates the gain Genb for adjusting the level of the baseband signal E0 by receiving them. The control unit 17 sends out, to the C-Plane transmission processing unit 124, information necessary to generate the C-Plane in the setting information of the relay node RN (for example, identification information of the relay node RN) which is input from an operator through the operation unit 18.

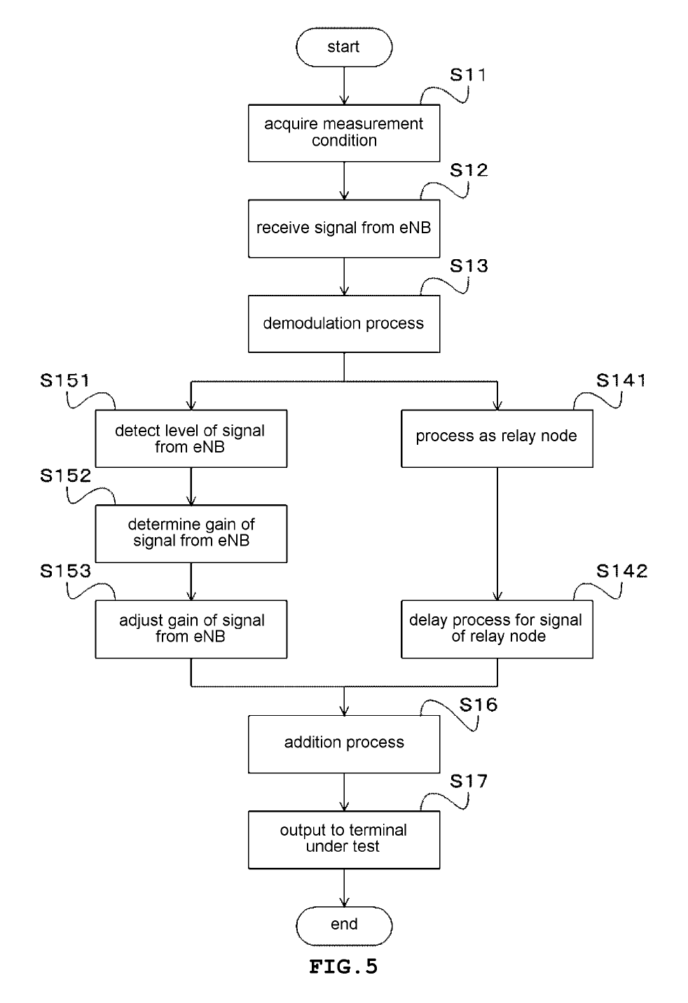

Next, a series of operations of the downlink processing unit 10 will be described with reference to FIG. 5. FIG. 5 is a flow diagram illustrating a series of operations of the downlink processing unit 10.

### Step S11

The control unit 17 receives the level Prn, the level difference Guser, and the delay D1 which are indicated as the measurement condition from an operator. The control unit 17 outputs the level Prn to the gain adjustment unit 131. In addition, the control unit 17 outputs the delay D1 to the delay processing unit 132. In addition, the control unit 17 outputs the level Prn and the level difference Guser to the gain determination unit 142.

### Step S12

The receiving unit 11 receives the RF signal E0′ transmitted from the eNB 500 in a time-division manner on the basis of a predetermined timing. The receiving unit 11 frequency-converts the received RF signal into an IF (intermediate frequency) signal, and performs an A/D conversion and a frequency shift on this IF signal, to thereby obtain a digital baseband signal E0. The receiving unit 11 outputs the baseband signal E0 to the demodulation unit 121 and the gain adjustment unit 143.

### Step S13

The demodulation unit 121 receives the baseband signal E0 from the receiving unit 11, and performs a demodulation process. The demodulated signal has a frame structure based on an encoding system (for example, OFDMA) in accordance with a predetermined communication scheme (LTE).

The demodulation unit 121 extracts a reference signal called Cell-Specific RS (Cell-Specific Reference Signal) from the demodulated signal. When the reference signal (Cell-Specific RS) is extracted from a resource element of a predetermined position in one sub-frame, the demodulation unit 121 outputs this reference signal to the level detection unit 141.

In addition, the demodulation unit 121 decodes a signal demodulated on the basis of the predetermined communication scheme mentioned above and extracts digital data. The demodulation unit 121 outputs the extracted digital data to the U-Plane regeneration processing unit 122. In addition, the demodulation unit 121 sends out information for generating a C-Plane to the C-Plane transmission processing unit 124. In addition, the demodulation unit 121 notifies the modulation unit 125 of a synchronization timing of the baseband signal E0.

### Step S141

The U-Plane regeneration processing unit 122 receives digital data from the demodulation unit 121. The U-Plane regeneration processing unit 122 regenerates the U-Plane from digital data on the basis of control information included in the C-Plane of the digital data. The U-Plane regeneration processing unit 122 outputs the regenerated U-Plane to the U-Plane transmission processing unit 123.

The U-Plane transmission processing unit 123 receives the U-Plane from the U-Plane regeneration processing unit 122. The U-Plane transmission processing unit 123 has the same wireless control function as that of the base station. The U-Plane transmission processing unit 123 performs a wireless control thereof on the received U-Plane. The U-Plane transmission processing unit 123 outputs the U-Plane, on which the wireless control is performed, to the modulation unit 125.

The C-Plane transmission processing unit 124 receives information from the demodulation unit 121 and the control unit 17, and generates data for controlling a network between the relay node simulated by the downlink processing unit 10 and the terminal under test 600, that is, the C-Plane. For example, setting of a transmission path between the simulated relay node RN and the terminal under test 600, a control of handover, or the like is performed on the basis of the generated C-Plane. The C-Plane transmission processing unit 124 outputs the generated C-Plane to the modulation unit 125.

The modulation unit 125 receives the U-Plane from the U-Plane transmission processing unit 123. In addition, the modulation unit 125 receives the C-Plane from the C-Plane transmission processing unit 124. The modulation unit 125 generates digital data by the received C-Plane and the U-Plane. The modulation unit 125 performs encoding and digital modulation on the generated digital data on the basis of a predetermined communication scheme and generates a baseband signal. In addition, the modulation unit 125 receives a synchronization timing from the demodulation unit 121. The modulation unit 125 performs a delay process on this baseband signal so that the generated baseband signal is in synchronization with the received synchronization timing. The modulation unit 125 outputs the baseband signal E1, on which the delay process is performed, to the gain adjustment unit 131.

The gain adjustment unit 131 receives the baseband signal E1 from the modulation unit 125. In addition, the gain adjustment unit 131 receives, from the control unit 17, information indicating level Prn of a signal which is output from the relay node set in advance as a measurement condition. The gain adjustment unit 131 determines a gain so that the level of the baseband signal E1 is changed to the level Prn, and adjusts the level of the baseband signal E1 on the basis of the gain.

Meanwhile, the gain adjustment unit 131 may calculate the amount of attenuation of the baseband signal E1 between the relay node RN assumed to be a real line and the terminal under test 600 (that is, mobile communication terminal UE), and may adjust a gain so that the level of the baseband signal E1 is changed to a level attenuated by this amount of attenuation from the level Prn. In this case, the gain adjustment unit 131 may receive, from the control unit 17, information indicating a distance (for example, distance L2) between the relay node set in advance and the terminal under test 600, and may calculate the amount of attenuation of the baseband signal on the basis of information indicating the distance.

The gain adjustment unit 131 outputs the baseband signal E1 of which the level is adjusted to the delay processing unit 132.

### Step S142

The delay processing unit 132 receives the baseband signal E1 of which the level is adjusted from the gain adjustment unit 131. In addition, the delay processing unit 132 receives information indicating a delay D1 from the control unit 17. The delay processing unit 132 provides the delay D1 to the baseband signal E1. The delay processing unit 132 outputs the baseband signal E1 provided with the delay to the adder 15.

### Step S151

The level detection unit 141 receives a reference signal from the demodulation unit 121. The level detection unit 141 detects the level of the reference signal as the level of the baseband signal E0. At this time, the level detection unit 141 detects, for example, an average value of reference signals in one sub-frame as a level Penb of the baseband signal E0. In addition, the level detection unit 141 may further acquire the average value of reference signals in one sub-frame during several ms, and may set a value smoothed by taking a moving average thereof as the level of the baseband signal E0. In addition, levels are not necessarily detected with respect to all the reference signals in one sub-frame, and for example, some of these reference signals may be decimated. The level detection unit 141 outputs the detected level Penb to the gain determination unit 142.

### Step S152

The gain determination unit 142 receives the level Penb of the baseband signal E0, received from the eNB 500, from the level detection unit 141. In addition, the gain determination unit 142 receives, from the control unit 17, information indicating the level Prn set in advance as the measurement condition and information indicating the level difference Guser. The level Prn shows the level of the RF signal E1′ which is output from the simulated relay node RN. In addition, the level difference Guser shows the level difference between the RF signal E0′ and the RF signal E1′ as shown in FIG. 4C. In this case, when the level of the RF signal E0′ after the attenuation as shown in FIG. 4C is set to Penb′, the expression of Penb′=Prn−Guser is established. The gain determination unit 142 calculates gain Genb for adjusting the level of the RF signal E0′ (that is, the level of the baseband signal E0) from Penb to Penb′, on the basis of the expression of Genb=Penb′−Penb=Prn−Penb−Guser. The gain determination unit 142 outputs information indicating the calculated gain Genb to the gain adjustment unit 143.

### Step S153

The gain adjustment unit 143 receives the baseband signal E0 from the receiving unit 11. In addition, the gain adjustment unit 143 receives information indicating the gain Genb from the gain determination unit 142. The gain adjustment unit 143 performs an adjustment by attenuating or amplifying the level of the baseband signal E0 on the basis of the gain Genb. Thereby, the level of the baseband signal E0 is adjusted to the level Penb′ as shown in FIG. 4C. The gain adjustment unit 143 outputs the baseband signal E0 of which the level is adjusted to the adder 15.

### Step S16

The adder 15 receives the baseband signal E1 provided with the delay from the delay processing unit 132. In addition, the adder 15 receives the baseband signal E0 of which the level is adjusted from the gain adjustment unit 143. The adder 15 adds the baseband signal E0 and the baseband signal E1, and outputs the added signal to the transmission unit 16.

### Step S17

The transmission unit 16 performs D/A conversion and frequency conversion on the added signal, and transmits an RF signal obtained thereby as a test signal toward the terminal under test 600.

As stated above, in the relay node simulator according to the present embodiment, the relay node RN is simulated, and a signal is generated in which the RF signal E0′ and the RF signal E1′ are multiplexed in a time division manner on the basis of the RF signal E0′ transmitted from the eNB 500 to thereby transmit the generated signal to the terminal under test 600. Thereby, it is possible to simulate a signal in which a signal from the relay node RN and a signal from the base station eNB are multiplexed in a time division manner, and to transmit the signal to the terminal under test 600.

In addition, the relay node simulator according to the present embodiment provides the delay D1 indicated as a measurement condition to the RF signal E1′, and thus simulates a delay of the RF signal E1′ based on the positional relationship between the base station eNB, the relay node RN, and the mobile communication terminal UE. Thereby, it is possible to simulate interference between the RF signal E0′ and the RF signal E1′ due to this delay.

Meanwhile, in the present embodiment, although the configuration in which the signal from the relay node RN and the signal from the base station eNB are multiplexed in a time division manner has been described by way of example, as mentioned above, the present invention can also be applied to a configuration in which a signal continues to be output from the base station without performing time division multiplexing, and the allocation of resource elements is controlled with respect to the signal of the base station and the signal from the relay node, to thereby prevent interference between these signals.

In addition, the relay node simulator according to the present embodiment determines the gain Genb on the basis of the level difference Guser indicated as a measurement condition, and adjusts the level of the RF signal E0′ transmitted from the eNB 500 on the basis of the gain Genb. Thereby, it is possible to simulate the attenuation of the RF signal E0′ depending on the distance LO between the base station eNB and the mobile communication terminal UE. In addition, an operator designates the desired level difference Guser as in a case where the SN ratio is set, by performing an operation to determine the gain Genb on the basis of the level difference Guser, thereby allowing the gain Genb for adjusting the level of the RF signal E0′ to be set. For this reason, an operator can easily perform the setting of a gain with respect to the relay node simulator.

Meanwhile, in the present embodiment, although it is configured such that the RF signal E0′ from the eNB 500 is received by the receiving unit 11, and is converted into a baseband signal, the receiving unit 11 may be omitted, and the baseband signal E0 before the conversion into the RF signal E0′ may be directly received. In this case, it is possible to perform the same test on a terminal under test by connecting pseudo-base station equipment capable of outputting the baseband signal E0 instead of, for example, the eNB 500 to the relay node simulator of the present invention. Herein, the baseband signal E0 before the conversion into the RF signal E0′ is a baseband signal corresponding to the RF signal E0′.

### DESCRIPTION OF REFERENCE NUMERALS AND SIGNS

1: relay node simulator

10: downlink processing unit

11: receiving unit

12: relay processing unit

121: demodulation unit

122: U-Plane regeneration processing unit

123: U-Plane transmission processing unit

124: C-Plane transmission processing unit

125: modulation unit

131: gain adjustment unit

132: delay processing unit

141: level detection unit

142: gain determination unit

143: gain adjustment unit

15: adder

16: transmission unit

17: control unit

18: operation unit

20: uplink processing unit

31: directional coupler

32: directional coupler

500: eNB

600: terminal under test

1. A relay node simulator that outputs a test signal obtained by simulating a signal in which a first RF signal from a base station and a second RF signal transmitted to a mobile communication terminal by a relay node receiving the first RF signal are multiplexed, comprising:
a relay processing unit that receives a first baseband signal corresponding to the first RF signal and generates a second baseband signal corresponding to the second RF signal on the basis of the first baseband signal;
a delay processing unit that provides a predetermined delay to the second baseband signal;
a gain adjustment unit that receives the first baseband signal and changes a level of the first baseband signal;
an adder that adds the first baseband signal, the level of which is changed and the second baseband signal provided with the delay; and
a transmission unit that converts an added signal into an RF signal and transmits a converted signal as the test signal.

2. The relay node simulator according to claim 1, further comprising:
a level detection unit that detects a level (Penb) of the first baseband signal;
an operation unit for inputting a desired value (Guser) of a level difference between a level of the first RF signal and a level of the second RF signal; and
a gain determination unit that determines a gain on the basis of the detected level of the first baseband signal and the desired value of the level difference,
wherein the gain adjustment unit changes the level of the first baseband signal on the basis of the determined gain.

3. The relay node simulator according to claim 2, wherein the first baseband signal is formed by a frame in which a plurality of resource elements are arranged, and a resource element located at a predetermined position in the plurality of resource elements is a pilot signal, a level of which does not fluctuate during a predetermined period of time,
the relay processing unit extracts the pilot signal included in the first baseband signal, and
the level detection unit detects a level of the extracted pilot signal as the level of the first baseband signal.

4. A test method of transmitting, to a mobile communication terminal to be tested, a test signal obtained by simulating a signal in which a first RF signal from a base station and a second RF signal transmitted to a mobile communication terminal by a relay node receiving the first RF signal are multiplexed, comprising:
a relay processing step of receiving a first baseband signal corresponding to the first RF signal and generating a second baseband signal corresponding to the second RF signal on the basis of the first baseband signal;
a delay processing step of providing a predetermined delay to the second baseband signal;
a gain adjustment step of receiving the first baseband signal and changing a level of the first baseband signal;
an addition step of adding the first baseband signal, the level of which is changed and the second baseband signal provided with the delay; and
a transmission step of converting an added signal into an RF signal and transmitting a converted signal as the test signal.

5. The test method according to claim 4, further comprising:
a level difference acquisition step of acquiring a desired value (Guser) of a level difference between a level of the first RF signal and a level of the second RF signal;
a level detection step of detecting a level (Penb) of the first baseband signal; and
a gain determination step of determining a gain on the basis of the detected level of the first baseband signal and the desired value of the level difference,
wherein in the gain adjustment step, the level of the first baseband signal is changed on the basis of the determined gain.

6. The test method according to claim 5, wherein the first baseband signal is formed by a frame in which a plurality of resource elements are arranged, and a resource element located at a predetermined position in the plurality of resource elements is a pilot signal, a level of which does not fluctuate during a predetermined period of time,
in the relay processing step, the pilot signal included in the first baseband signal is extracted, and
in the level detection step, a level of the extracted pilot signal is detected as the level of the first baseband signal.
